(19) United States
(12) Patent Application Publication
(10) Pub. No.: US 2004/0140908 A1
(43) Pub. Date: Jul. 22, 2004

(54) Utility usage rate monitor

(76) Inventors: Paul Gladwin, Pymble (AU); Ross Halliwell, Ingleside (AU)

Correspondence Address: JOEL D. SKINNER, JR., SKINNER AND ASSOCIATES, 212 COMMERCIAL ST., HUDSON, WI, 54016, US

(21) Appl. No.: 10/474,659

(22) PCT Filed: Apr. 12, 2002
(86) PCT No.: PCT/AU02/00474

(30) Foreign Application Priority Data
Apr. 12, 2001 (AU) PR 4414

(51) Int. Cl. G08C 15/06

(52) U.S. Cl. 340/870.02

(57) ABSTRACT

A utility usage rate monitor that allows a utility consumer to monitor their current rate of consumption of a utility service. The monitor can display the rate of consumption in a form that has particular relevance to the consumer such as the cost or rate of expenditure on the utility or a greenhouse gas emission reduction rate. The monitor has a transducer (1) that senses the rate that the utility is being supplied to the consumer. The transducer produces a signal and sends it to a remotely located consumer interface (15) via a transmission link (16). An awareness of the expenditure or greenhouse gas emission associated with the current levels of consumption of the utility can motivate the consumer to modify their consumption habits and minimise wastage.

### FIELD OF THE INVENTION

The present invention relates to the consumption of municipal utility services and in particular the ongoing monitoring of the rate of usage and cost of utility services for a particular utility consumer.

### BACKGROUND OF THE INVENTION

Any discussion of the prior art throughout the specification should in no way be considered as an admission that such prior art is widely known or forms part of common general knowledge in the field.

The vast majority of domestic households and commercial premises in the developed world consume utilities such as water, natural gas, heating oil, district water heating and/or electricity. In most cases, the utility is supplied to each individual consumer (that is, the entity that holds an account with the utility provider) through an accurate revenue meter that allows the utility service provider to periodically read and measure the level of consumption of the utility. The total consumption for that period is converted to a cost in accordance with the utility provider's charges and invoiced to the consumer.

While it is possible for the consumer to read the meter at any time in order to assess their consumption the majority of older mechanical style meters are often difficult or inconvenient to read. Even with the new generation of smart electronic consumption revenue meters the focus is to provide the utility with a convenient means of data acquisition and billing, rather than providing timely and convenient information to the consumer. The consumer would also need to know the costs per unit of consumption in order to calculate the monetary value of any particular utility they have used. This is generally inconvenient and most consumers are only made aware of their consumption level when invoiced by the utility supplier after a period of time, usually about three months.

For the purposes of illustration the present invention will be described with particular reference to supply of electricity to a domestic household or commercial premises. However, it will be appreciated that this is only one example of the invention and should not be viewed as restrictive in any way on the scope of the broad inventive concept.

The supply of electrical power in many developed countries around the world struggles to keep pace with demand. In an effort to make consumers more conservative in their usage, the price per unit of electrical energy has increased significantly. In a further effort to smooth the fluctuations in the levels of demand during the twenty four hour period, some electrical power supply companies have reduced the costs of electricity during traditional off peak periods.

Environmental concerns about the effect of greenhouse gas emissions from thermal generating power stations and potential dangers from nuclear power plants has produced a worldwide search for alternative renewable and sustainable energy sources.

Government authorities are also actively encouraging energy conservation, more efficient electrical appliances and use of power in order to reduce greenhouse gas emissions and fuel costs. Unfortunately, these measures have only met with limited success as consumers often fail to alter their long-standing consumption habits. The costs of the electricity is only brought to their attention at the end of the particular billing period used by the electricity retailing company (typically every three months) and in between invoices there is a natural tendency to revert to old habits. Furthermore, individuals within the household or commercial premises that consume electricity may not be aware of the costs or the associated environmental consequences because the payment of these invoices is not their responsibility. In these circumstances, there is little motivation for these individuals to amend their consumption habits or to appreciate the nexus between consumption and conservation.

### SUMMARY OF THE INVENTION

It is an object of the present invention to overcome or ameliorate at least one of the disadvantages of the prior art, or to provide a useful alternative.

According to a first aspect, the present invention provides a utility usage rate monitor for monitoring the rate of consumption of utility service supplied to a consumer, the usage rate monitor including:

a transducer adapted to sense the rate of supply of the utility service to the consumer and produce a signal indicative of the sensed rate of supply,

an interface adapted to receive a signal from the transducer and provide the consumer with a corresponding indication of the rate of consumption of the utility service; and

a transmission link for transmitting signals from the transducer to the interface.

According to a second aspect, the present invention provides a utility transducer for use in a utility usage rate monitoring system that provides a consumer with an indication of their rate of consumption of a utility, the transducer including:

a sensor to sense the rate of supply of the utility to the consumer and produce a corresponding signal, the sensor being further adapted to provide the signal to a transmission link for transmitting the signal to a remotely positioned interface adapted to produce an indication of the rate of utility consumption in a form that is readily understandable to the consumer.

According to a third aspect, the present invention provides a method of monitoring the rate of consumption of a utility supplied to a consumer, the method including:

sensing the rate of utility consumption to the utility service to the consumer in order to produce a signal indicative of the rate of supply, transmitting the signal to a remotely located consumer interface; and

providing an indication of the rate of utility consumption to the consumer via the interface.

According to another aspect, the present invention provides a utility consumer interface for use in a utility usage rate monitoring system that senses the rate of supply of a utility using a transducer that produces a signal corresponding to the sensed rate and provides the signal to a transmission link to transmit the signal to the interface remotely positioned from the transducer, the interface being adapted to convert the signal from a transmission link to an indication of the rate of utility consumption in a form that is readily understandable to the consumer.

It will be appreciated that the indication of the rate of consumption may be in the form of an approximate rate of expenditure, or a greenhouse gas production rate, or any other measure that can be related to the rate of consumption.

The present invention allows a utility consumer to monitor their rate of consumption either periodically or on an ongoing basis from within their house or workplace and use this to instantaneously modify their consumption habits. It can also serve to limit wastage of any utility supplied to a household or commercial premises by making the consumer aware of their actual rate of consumption including any leakage, or appliances that have been inadvertently left on or unattended.

The overall safety of the appliance or premises will also be enhanced if the leakage or unattended operation can be remotely monitored by reference to the rate of utility consumption.

Preferably, the interface converts the signal corresponding to the rate of utility consumption into a rate of monetary expenditure on the utility. In another preferred form, the interface calculates the rate of monetary expenditure in accordance with the charges levied by the utility supplier taking into account any cost fluctuations related to peak and off peak periods, or level of demand exceeding a predetermined level.

In some forms of the invention, the interface may have a visual display of the monetary rate of expenditure. However, it could equally provide the indication in an audio format. For example, an alarm sounds when a predetermined maximum consumption rate is exceeded. Preferred embodiments of the invention may continuously sense the rate of supply and display the rate of expenditure however, it could just as conveniently sense the rate of supply at a regular predetermined intervals or even when prompted by the consumer. Conveniently, the interface may also be adapted to calculate and display an indication of the total consumption for a set period of time. Again, the indication may be an approximate cost of the amount of utility consumed for the set period, or the mass of greenhouse gas emission that is associated with the quantity of utility consumed for the set period.

The transmission link may be a length of electrical wire extending from the transducer to the interface or a radio transmitter and receiver set at the transducer and the interface respectively. The transmission link may also be the electrical wiring to sockets within the domestic household or commercial premises, wherein the transducer is capable of sending a modulated signal through the electrical wiring. The transmission link may also use the Internet wherein the interface is a remotely located computer terminal. Furthermore, the transmission link may use a cellular telephone network wherein the interface is a cellular telephone.

In some embodiments of the present invention, the utility supply is the electrical power supply to a domestic household or commercial premises. The electricity meter or fuses will usually be housed in a metal box. In a preferred form of these embodiments, the transducer is mounted externally beside a meter box or fuse box used by the utility supplier to measure the total consumption of electrical power to the household or commercial premises. This is often advantageous because the meter or fuse box can hamper a wireless transmitter. In a further preferred form, the sensor is a current transducer externally fitted to each electrical conductor inputting the electrical power supply to the domestic household or commercial premises. Typically, the current transducer is capable of sensing current up to 70 amps per phase and is adaptable to most commonly used domestic and light industrial power supply voltages and frequencies.

In a particular preferred form, the transmitter is battery powered and transmits the signal to the remotely positioned receiver every 3 seconds for a 100 milli-second period.

Typically, the transducer would sense the rate of supply of electric power through up to 3 phase input conductors via separate current transducers and linearly add each of the outputs from the respective current transducers to give the signal provided to the transmitter. It is envisaged that the signal will be typically ±5% accurate in accordance with fluctuations in the power factor, voltage and mains frequency. In a preferred form the transducer is capable of measuring rates of supply between 20 watts and 24 kW per input conductor. Typically, the transmitter would run at 433 MHz with an output power of less than 4 dBm. In a further preferred form, the transmitter would have an aerial to transmit signals up to 100 m to the receiver. A further preferred form provides a light emitting diode that flashes whenever the transmitter is sending the signal in order to indicate to the consumer that the transmitter is still operational. In a particularly preferred form, the transmitter monitors the battery power levels and transmits battery status information to the interface which is adapted to alert the consumer when fresh batteries are required.

One form of the invention is particularly suitable for use with “smart” meters (as they are known). A smart electricity meter electronically senses the electrical power consumption and stores the consumption information on a computer chip. The utility provider can easily interrogate the stored information with a hand-held wireless reader or via an Internet like This gives the utility provider a convenient means of acquiring revenue data as well as other information for statistical analysis. Throughout this specification, the term “smart meter” will be understood to be a reference to this type of utility meter.

In view of the foregoing, in some embodiments the transducer is adapted to receive and ampere current signal from a smart meter. It will be appreciated that the signal from the smart meter may be in digital or analog form and is converted to a suitable form for transmission to the interface via the transmission link.

In some preferred embodiments, the interface is portable. Furthermore, the transmitter and receiver may selectively operate on a number of predetermined frequencies or even spread spectrum In a further preferred form, the visual display is a four digit liquid crystal display (LCD) showing the rate of expenditure in dollars and cents per hour such that a maximum of $99.99c per hour can be displayed. In further preferred forms, the visual display includes a low battery power light emitting diode, dollar and cent symbols, a cents per hour symbol, a cents per unit symbol, a receiver out of transmission range symbol, a kilowatt power signal, an ampere current signal, inside ambient temperature and relative humidity symbols in either degrees Fahrenheit or Celsius and an indication of equivalent greenhouse gas emission levels from thermal power generation.

A preferred embodiment of the interface will also allow the consumer to adjust the unit price of the electrical energy supplied. In a particular preferred embodiment, the unit price of the electrical energy supply automatically adjusts to mirror the electricity supplier's cost structure relating to peak and off peak charges.

### BRIEF DESCRIPTION OF THE DRAWING

Preferred embodiments of the invention will now be described, by way of example only, with reference to the accompanying drawing in which:

FIG. 1 shows a schematic view of a utility usage rate monitor according to the present invention

### DETAILED DESCRIPTION OF THE PREFERRED EMBODIMENTS

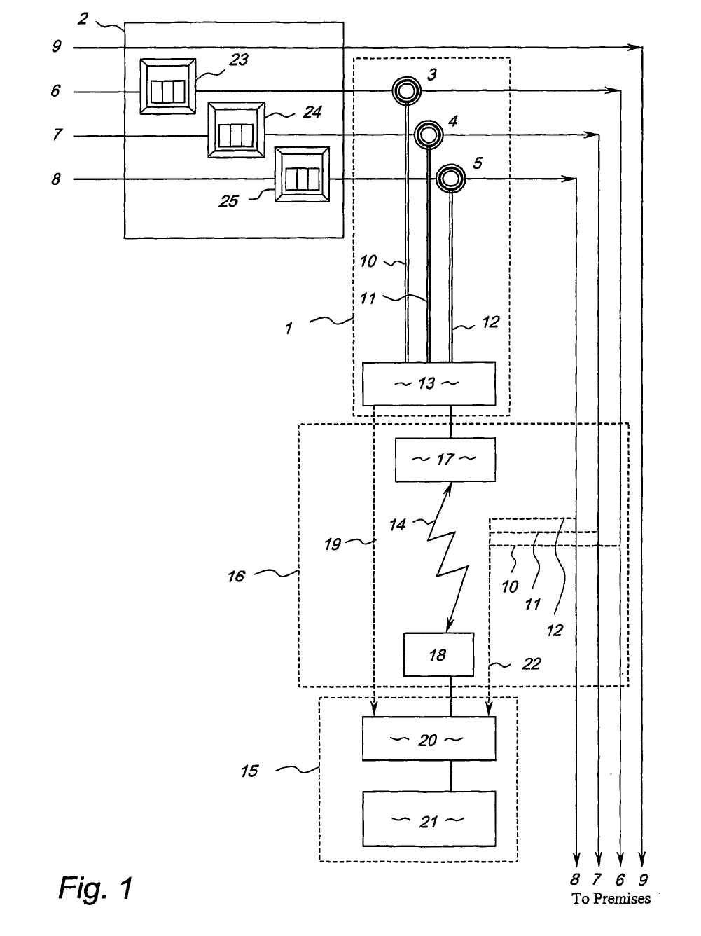

The utility usage rate monitor shown in FIG. 1 is configured specifically for monitoring the rate of consumption of electrical energy by a domestic household. However, it will be readily appreciated that corresponding components can be substituted in order to make the monitor suitable for gas, oil or water supplies. A transducer 1 is mounted next to the electricity meter box or fuse box 2 such that current transducers 3, 4 and 5 engage the conductors 6, 7 and 8 after they have passed through the revenue meters 23, 24 and 25. These conductors carry the three active phases of a three phase electrical power input. The fourth line 9 into the meter box 2 is the neutral line.

The electricity usage rate monitor is suitable for use in single phase, two phase or three phase installations or on any of one or more individual circuits connected to any number of phases, depending upon customer preference. There is no theoretical limit on the number of circuits that may be monitored, although in practice the preferred embodiment of the invention is limited to three phases.

In the three phase variant of the invention, the current transducers 3, 4 and 5 sense the rate of electrical energy being supplied through each of the lines 6, 7 and 8 to provide respective output signals 10, 11 and 12 to an electronic sampling, converting and summing circuit 13 which adds the signals 10, 11 and 12 to produce an output signal 14 that corresponds to the root mean square (RMS) total rate of electrical current being supplied to the premises.

The signal 14 is sent to a consumer interface 15 via a transmission link 16. The transmission link 16 may be a wireless transmitter 17 and receiver 18 or alternatively an electrical conductor 19. The transmission link may also be a modulated signal 22 which is transmitted via a live conductor circuit into the premises to the receiver 18 which is connected to a power outlet point (not shown).

In the case of a transmitter 17 and receiver 18, the transmitter would be mounted external to the meter box or fuse box 2, for ease of installation. The meter or fuse box is often made of metal and externally mounting the transmitter 17 ensures that the metal does not interfere with the wireless transmissions. Mounting the transmitter externally also allows easy access for battery replacement.

The current transducers 3, 4 and 5 are capable of measuring up to 70 amps through each of the input lines 6, 7 and 8. The transmitter 17 runs on 2×AA alkaline batteries (not shown) which typically have a life of about 2500 mAhrs. The current drawn by the transmitter 17 is less than a 150×10⁻⁶ A and this gives a battery life of approximately 550 days before the battery power has been depleted by 80%. This would give the usage rate monitor a six months shelf life followed by approximately 1 year operation, as long as the transmitter operates once every 3 seconds for a maximum of 100 ms during which it only draws 15 mA.

The transducer I will not take into account the power factor and mains frequency fluctuations and therefore the power supply sensed will be accurate to typically 15%. This is in line with the basic intention of the monitor which is to provide an indication of the power consumed at any particular time rather than a highly precise reading of the power being supplied to the household at any given instant. Future embodiments can be made to take into account the actual real time voltage and power factor for more accurate monitoring. Typically, the transducer 1 will measure input power from 20 Watts to 16.8 kilowatts per input line. The transmitter 17 will operate at 433.92 Mfz with an output power of less than 4 dBm as this places it in the free to air band. The aerial (not shown) may be a simple wire approximately 150 mm long or an enclosed coil type located external or inside the transmitter and receiver, depending upon aesthetics, required range and cost.

An LED that flashes every time the transmitter 17 operates provides an indication that is still working. The transmitter should also include a circuit to monitor the battery levels and transmit battery status data to the interface 15.

The consumer interface 15 is a portable unit, which can be positioned wherever it would be conveniently and frequently viewed. Of course, multiple interfaces may be positioned around the premises so that more occupants will view the consumption rates more regularly. If neighbouring premises both have usage rate monitors according to the present invention, the transmitters 17 and receivers 18 can be adapted to operate on any one of number of different pre-selected at least 8 bit rolling codes and random timing sequences.

The interface 15 receives the RMS value of electrical current signal 14 from the receiver 18 and inputs it to an RMS voltage multiplier, programmable computer chip circuit 20 which converts the signal into an electrical power consumption rate. The effects of power factor correction are neglected for simplicity of installation and calibration and the fact that the invention is not designed to have revenue metering accuracy. The software incorporated into this circuit is also used to calculate the monitory expenditure rate using the cost per unit of electrical energy charged by the electricity supplier and/or the equivalent greenhouse gas consumption rate.

The interface 15 has several push buttons allowing the consumer to input the cost per unit, or tariff, of electrical energy into the software program which operates circuit 20. In a variation to the invention, it is also possible to programme the circuit 20 to automatically adjust in accordance with variations in the cost per unit related to peak and off peak charges by incorporating a real time clock circuit.

The expenditure rate is shown on a large, easy to read visual display 21. A 4-digit custom LCD shows the power usage in $ and c per hour up to a maximum of $99.99c per hour. This comfortably accommodates a three phase 240 volt input from conductors 6, 7 and 8 of 70 Amps each at a maximum tariff of 99c per kW hour. In the unlikely event of this situation, the rate shown would be $49.90 per hour.

The visual display 21 would also include symbols related to the battery status, an ‘out of transmission range’ indicator and the applicable tariff rate. The interface 15 may also include temperature and humidity sensors (not shown) so that the display 21 also shows the current ambient temperature and relative humidity. In houses with heating or cooling systems, current temperature and humidity helps occupants to forge an appreciation of the level of expenditure necessary to maintain a certain indoor environment.

The invention is also particularly well suited for use in conjunction with so-called “smart” electricity meters. The smart meter is already arranged to transmit consumption information for remote data acquisition, however, the utility provider uses this solely for revenue purposes and/or statistical analysis. The transducer of the present invention may be adapted to receive an ampere current signal or a kilowatt power signal, in either an analog or digital format, from the smart meter. This signal can then be transformed into a format suitable for transmission to the interface where it is shown on the display. This variant of the present invention can be offered as an additional feature for future smart meters or an easily installed retrofit to existing smart meters. This is because the invention so readily adapts to the wireless technology or similar means used to enable rapid and remote data acquisition from these meters.

A utility usage rate monitor according to the present invention allows households or businesses to monitor their present rate of utility consumption as regularly as they wish. During higher rates of consumption, the consumer is motivated to consider ways of conserving their use. In particular, the monitoring of ambient temperature and relative humidity inside the premises, allows the customer to regulate high load electric heaters or air conditioners to provide an optimal balance between personal comfort and the cost of operation. For example, the occupant may choose to wear additional clothing or restrict heating to certain rooms in order to lower utility usage. Furthermore, the occupants may not be aware that exterior lights or appliances in other rooms are on unnecessarily until the consumption rate monitor brings this to their attention. Converting the consumption rate to a monetary expenditure rate and/or a greenhouse production rate raises the motivation for occupants of the household to focus on conservation of their usage and to turn off appliances between use.

Being constantly aware of the cost or environmental impact of utility usage, focuses attention on wasteful energy practices and helps to instil more efficient consumption habits. Of course, the circuit 20 could also allow the manual adjustment of the cost per unit of energy to a level above the actual cost in order to further motivate the occupants to minimise their usage, particularly in those communities that experience electricity shortages in peak periods.

If the utility supplier has a pricing structure that reduces the cost per unit during an off-peak period, the consumer is more likely to be mindful of when the household is being charged at off peak rates. This can prompt the consumer to operate large appliances at these times rather than during peak times. Furthermore, it allows an occupant of a household to conveniently check that all appliances and lighting have been switched off prior to leaving the house vacant for short periods of time, thus adding to the safety and security of the premises.

The present invention has been described herein by way of example only. Ordinary workers in this field will readily recognise many variations and modifications which do not depart from the spirit and scope of the broad inventive concept.

1. A utility usage rate monitor for monitoring the rate of consumption of utility service supplied to a consumer, the usage rate monitor including:
a transducer adapted to sense the rate of supply of the utility service to the consumer and produce a signal indicative of the sensed rate of supply;
an interface adapted to receive a signal from the transducer and provide the consumer with a corresponding indication of the rate of consumption of the utility service; and
a transmission link for transmitting signals from the transducer to the interface.

2. A utility usage rate monitor according to claim 1, wherein the interface converts the signal corresponding to the rate of utility consumption into a rate of monetary expenditure on the utility.

3. A utility usage rate monitor according to claim 1, wherein the interface calculates the rate of monetary expenditure in accordance with the charges levied by the utility supplier taking into account any cost fluctuations related to peak and off peak periods, or level of demand exceeding a predetermined level.

4. A utility usage rate monitor according to claim 1, wherein the interface has a visual display of the monetary rate of expenditure.

5. A utility usage rate monitor according to claim 1, wherein the interface provides the indication in an audio format.

6. A utility usage rate monitor according to claim 1, wherein an alarm sounds when a predetermined maximum consumption rate is exceeded.

7. A utility usage rate monitor according to claim 6, wherein the monitor continuously senses the rate of supply and display the rate of expenditure.

8. A utility usage rate monitor according to claim 1, wherein the monitor senses the rate of supply at a regular pre-determined intervals.

9. A utility usage rate monitor according to claim 1, wherein the monitor senses the rate of supply when prompted by the consumer.

10. A utility usage rate monitor according to claim 1, wherein the interface is adapted to calculate and display an indication of the total consumption for a set period of time.

11. A utility usage rate monitor according to claim 10, wherein the indication is an approximate cost of the amount of utility consumed for the set period.

12. A utility usage rate monitor according to claim 10, wherein the indicator is the mass of greenhouse gas emission that is associated with the quantity of utility consumed for the set period.

13. A utility usage rate monitor according to claim 1, wherein the transmission link is a length of electrical wire extending from the transducer to the interface.

14. A utility usage rate monitor according to claim 1, wherein the transmission link is a radio transmitter and receiver set at the transducer and the interface respectively.

15. A utility usage rate monitor according to claim 1, wherein the transmission link may also be the electrical wiring to sockets within the domestic household or commercial premises, wherein the transducer is capable of sending a modulated signal through the electrical wiring.

16. A utility usage rate monitor according to claim 1, wherein the transmission link uses the Internet wherein the interface is a remotely located computer terminal.

17. A utility usage rate monitor according to claim 1, wherein the transmission link may use a cellular telephone network wherein the interface is a cellular telephone.

18. A utility usage rate monitor according to claim 1, wherein the utility supply is the electrical power supply to a domestic household or commercial premises.

19. A utility usage rate monitor according to claim 18, wherein the transducer is mounted externally beside a meter box or fuse box used by the utility supplier to measure the total consumption of electrical power to the household or commercial premises.

20. A utility usage rate monitor according to claim 19, wherein the sensor is a current transducer externally fitted to each electrical conductor inputting the electrical power supply to the domestic household or commercial premises.

21. A utility usage rate monitor according to claim 19, wherein the current transducer is capable of sensing current up to 70 amps per phase and is adaptable to most commonly used domestic and light industrial power supply voltages and frequencies.

22. A utility usage rate monitor according to claim 19, wherein the transmitter is battery powered and transmits the signal to the remotely positioned receiver every 3 seconds for a 100 multi-second period.

23. A utility usage rate monitor according to claim 20, wherein the transducer senses the rate of supply of electric power through up to 3 phase input conductors via separate current transducers and linearly add each of the outputs from the respective current transducers to give the signal provided to the transmitter.

24. A utility usage rate monitor according to claim 23, wherein the transducer is measures rates of supply between 20 watts and 24 kW per input conductor.

25. A utility usage rate monitor according to claim 22, wherein the transmitter operates at 433 MHz with an output power of less than 4 dBm.

26. A utility usage rate monitor according to claim 25, wherein the transmitter has an aerial to transmit signals up to 100 m to the receiver.

27. A utility usage rate monitor according to claim 26, wherein the transmitter has a light emitting diode that flashes whenever the transmitter is sending the signal in order to indicate to the consumer that the transmitter is still operational.

28. A utility usage rate monitor according to claim 27, wherein the transmitter monitors the battery power levels and transmits battery status information to the interface which is adapted to alert the consumer when fresh batteries are required.

29. A utility usage rate monitor according to claim 1, wherein the transducer is adapted to receive and ampere current signal from a smart meter.

30. A utility usage rate monitor according to claim 29, wherein the signal from the smart meter may be in digital or analog form and is converted to a suitable form for transmission to the interface via the transmission link.

31. A utility usage rate monitor according to claim 30, wherein the interface is portable.

32. A utility usage rate monitor according to claim 31, wherein the transmitter and receiver selectively operates on a number of predetermined frequencies or even spread spectrum.

33. A utility usage rate monitor according to claim 6, wherein the visual display is a four digit liquid crystal display (LCD) showing the rate of expenditure in dollars and cents per hour such that a maximum of $99.99c per hour can be displayed.

34. A utility usage rate monitor according to claim 33, wherein the visual display includes a low battery power light emitting diode, dollar and cent symbols, a cents per hour symbol, a cents per unit symbol, a receiver out of transmission range symbol, a kilowatt power signal, an ampere current signal, inside ambient temperature and relative humidity symbols in either degrees Fahrenheit or Celsius and an indication of equivalent greenhouse gas emission levels from thermal power generation.

35. A utility usage rate monitor according to claim 34, wherein the interface allows the consumer to adjust the unit price of the electrical energy supplied.

36. A utility usage rate monitor according to claim 35, wherein the unit price of the electrical energy supply automatically adjusts to mirror the electricity supplier's cost structure relating to peal& and off peak charges.

37. A utility transducer for use in a utility usage rate monitoring system that provides a consumer with an indication of their rate of consumption of a utility, the transducer including:
a sensor to sense the rate of supply of the utility to the consumer and produce a corresponding signal, the sensor being further adapted to provide the signal to a transmission link for transmitting the signal to a remotely positioned interface adapted to produce an indication of the rate of utility consumption in a form that is readily understandable to the consumer.

38. A utility transducer according to claim 37, wherein the utility supply is the electrical power supply to a domestic household or commercial premises.

39. A utility transducer according to claim 38, wherein the transducer is mounted externally beside a meter box or fuse box used by the utility supplier to measure the total consumption of electrical power to the household or commercial premises.

40. A utility transducer according to claim 39, wherein the sensor is a current transducer externally fitted to each electrical conductor inputting the electrical power supply to the domestic household or commercial premises.

41. A utility transducer according to claim 41, wherein the current transducer is capable of sensing current up to 70 amps per phase and is adaptable to most commonly used domestic and light industrial power supply voltages and frequencies.

42. A utility transducer according to claim 41, wherein the transducer senses the rate of supply of electric power through up to 3 phase input conductors via separate current transducers and linearly add each of the outputs from the respective current transducers to give the signal provided to the transmitter.

43. A utility transducer according to claim 42, wherein the transducer is measures rates of supply between 20 watts and 24 kW per input conductor.

44. A utility transducer according to claim 43, wherein the transducer is adapted to receive and ampere current signal from a smart meter.

45. A utility transducer according to claim 44, wherein the signal from the smart meter may be in digital or analog form and is converted to a suitable form for transmission to the interface via the transmission link.

46. A utility consumer interface for use in a utility usage rate monitoring system that senses the rate of supply of a utility with a transducer that produces a signal corresponding to the sensed rate and provides the signal to a transmission link to transmit the signal to the interface remotely positioned from the transducer, the interface being adapted to convert the signal from a transmission link to an indication of the rate of utility consumption in a form that is readily understandable to the consumer.

47. A utility consumer interface according to claim 46, wherein the interface converts the signal corresponding to the rate of utility consumption into a rate of monetary expenditure on the utility.

48. A utility consumer interface according to claim 47, wherein the interface calculates the rate of monetary expenditure in accordance with the charges levied by the utility supplier taking into account any cost fluctuations related to peak and off peak periods, or level of demand exceeding a predetermined level.

49. A utility consumer interface according to claim 48, wherein the interface has a visual display of the monetary rate of expenditure.

50. A utility consumer interface according to claim 49, wherein the interface provides the indication in an audio format.

51. A utility consumer interface according to claim 50, wherein an alarm may sound when a predetermined maximum consumption rate is exceeded.

52. A utility consumer interface according to claim 47, wherein the visual display is a four digit liquid crystal display (LCD) showing the rate of expenditure in dollars and cents per hour such that a maximum of $99.99c per hour can be displayed.

53. A utility consumer interface according to claim 52, wherein the visual display includes a low battery power light emitting diode, dollar and cent symbols, a cents per hour symbol, a cents per unit symbol, a receiver out of transmission range symbol, a kilowatt power signal, an ampere current signal, inside ambient temperature and relative humidity symbols in either degrees Fahrenheit or Celsius and an indication of equivalent greenhouse gas production rates from thermal power generation.

54. A utility consumer interface according to claim 47, wherein the interface allows the consumer to adjust the unit price of the electrical energy supplied.

55. A method of monitoring the rate of consumption of a utility supplied to a consumer, the method including:
sensing the rate of supply of the utility service to the consumer in order to produce a signal indicative of the rate of supply;
transmitting the signal to a remotely located consumer interface; and
providing an indication of the rate of utility consumption to the consumer via the interface.

56. A method according to claim 55, wherein the indication is provided in a form that is readily understandable to the consumer.

57. A method according to claim 56, wherein the utility service is the supply of electrical power to a domestic household or commercial premises and the indication is provided in the form of a rate of monetary expenditure.

58. A method according to claim 56, wherein the utility service is the supplier of electrical power to a domestic household or commercial premises and the indication is provided as a rate of production of greenhouse gases from thermal power generation.
